(19) United States
(12) Patent Application Publication
(10) Pub. No.: US 2007/0224336 A1
(43) Pub. Date: Sep. 27, 2007

(54) Functional food ingredient and process for preparing same

(76) Inventors: Traci Hamersen, St. Louis, MO (US); Thomas L. Krinski, Granite City, IL (US)

Correspondence Address: SOLAE, LLC, P. O. BOX 88940, ST. LOUIS, MO, 63188, US

(21) Appl. No.: 11/386,439

(22) Filed: Mar. 22, 2006

(51) Int. Cl. A23L 1/20

(52) U.S. Cl. 426/656; 426/634

(57) ABSTRACT

The present invention is directed to a functional food ingredient, comprising;
a soy protein isolate, comprising;
de-oiling hexane treated soybean flakes;
heat treating the de-oiled hexane treated soybean flakes to a hexane content of below 200 parts per million at a temperature of from about 200° F. to about 210° F., wherein the soybean flakes are from high beta conglycinin soybeans;
mixing the heat treated soybean flakes with water to form a slurry;
removing fiber from the slurry to produce a liquor;
adding an acid to the liquor to produce a precipitate of curds and a liquid of whey;
separating the curds and the whey;
washing the curds with water;
adjusting the pH of the washed curds to about 7 and
drying the pH adjusted material to produce a soy protein isolate having a beta conglycinin content of from about 35% to about 85% and a glycinin content of from about 5% to about 40%.

### FIELD OF THE INVENTION

The present invention relates to a functional food ingredient of a soy protein isolate and to a process for the preparation of the soy protein isolate wherein the isolate has a beta conglycinin content of from about 35% to about 85% and a glycinin content of from about 5% to about 40%.

### BACKGROUND OF THE INVENTION

Soy protein materials have seen extensive use as functional food ingredients. Soy protein materials are used as an emulsifier in meats—including frankfurters, sausages, bologna, ground and minced meats and meat patties—to bind the meat and give the meat a good texture and a firm bite. Another common application for soy protein materials as functional food ingredients is in creamed soups, gravies, and yogurts where the soy protein material acts as a thickening agent and provides a creamy viscosity to the food product. Soy protein materials are also used as functional food ingredients in numerous other food products such as dips, dairy products, tuna, breads, cakes, macaroni, confections, whipped toppings, baked goods and many other applications.

Soy protein isolates are soy protein materials that are commonly used as functional food ingredients due to their high protein content. Soy protein isolates are the most highly refined commercially available soy protein containing products. Soy protein isolates are processed to increase the soy protein content relative to whole soybeans and relatively unprocessed soy protein materials such as soy flakes, soy grits, soy meal and soy flour. Soy protein isolates, the most highly refined soy protein product, are processed to contain at least 90% soy protein and little or no water soluble oligosaccharides/carbohydrates or fiber.

Soy protein isolates are particularly effective functional food ingredients due to the versatility of soy protein and its high content of soy protein. Soy protein isolates provide gelling properties which contribute to the texture in ground and emulsified meat products. The gel structure provides dimensional stability to a cooked meat emulsion which gives the cooked meat emulsion a firm texture and gives chewiness to the cooked meat emulsion, as well as provides a matrix for retaining moisture and fats. Soy protein isolates also act as an emulsifier in various food applications since soy proteins are surface active and collect at oil-water interfaces, inhibiting the coalescence of fat and oil droplets. The emulsification properties of soy protein allows soy protein isolates to be used to thicken food products such as soups and gravies. Soy protein further absorbs fat, likely as a function of its emulsification properties, and promotes fat binding in cooked foods, thereby decreasing “fatting out” of the fat in the process of cooking. Soy proteins also function to absorb water and retain it in finished food products due to the hydrophilic nature of the numerous polar side chains along the peptide backbone of soy protein. The moisture retention of a soy protein isolate may be utilized to decrease cooking loss of moisture in a meat product, providing a yield gain in the cooked weight of the meat. The retained water in the finished food products is also useful for providing a more tender mouthfeel to the product.

Soy protein isolates are highly processed, and entail an expense, particularly on a commercial scale. Soy protein isolates are formed by extracting soy protein and water soluble carbohydrates from soy flakes or soy flour with an alkaline aqueous extractant. The aqueous extract, along with the soluble protein and soluble carbohydrates, is separated from materials that are insoluble in the extract, mainly fiber. The extract is then treated with an acid to adjust the pH of the extract to the isoelectric point of the protein to precipitate the protein from the extract. The precipitated protein is separated from the extract, which retains the soluble carbohydrates, and is dried after being adjusted to a neutral pH or is dried without any pH adjustment. On a commercial scale, these steps result in significant costs.

### SUMMARY OF THE INVENTION

In one aspect, the present invention is directed to a functional food ingredient, comprising;

a soy protein isolate having a beta conglycinin content of from about 35% to about 85% and a glycinin content of from about 5% to about 40% and wherein the soy protein isolate is prepared by a process, comprising;

de-oiling hexane treated soybean flakes;

heat treating the de-oiled hexane treated soybean flakes to a hexane content of below 200 parts per million at a temperature of from about 200° F. to about 210° F., wherein the soybean flakes are from high beta conglycinin soybeans;

mixing the heat treated soybean flakes with water to form a slurry;

removing fiber from the slurry to produce a liquor;

adding an acid to the liquor to produce a precipitate of curds and a liquid of whey;

separating the curds and the whey;

washing the curds with water;

adjusting the pH of the washed curds to about 7 and

drying the pH adjusted material to produce a soy protein isolate having a beta conglycinin content of from about 35% to about 85% and a glycinin content of from about 5% to about 40%.

In another aspect, the present invention is directed to process for preparing a soy protein isolate functional food ingredient, the process comprising;

de-oiling hexane treated soybean flakes;

heat treating the de-oiled hexane treated soybean flakes to a hexane content of below 200 parts per million at a temperature of from about 200° F. to about 210° F., wherein the soybean flakes are from high beta conglycinin soybeans;

mixing the heat treated soybean flakes with water to form a slurry;

removing fiber from the slurry to produce a liquor;

adding an acid to the liquor to produce a precipitate of curds and a liquid of whey;

separating the curds and the whey;

washing the curds with water;

adjusting the pH of the washed curds to about 7 and drying the pH adjusted material to produce a soy protein isolate having a beta conglycinin content of from about 35% to about 85% and a glycinin content of from about 5% to about 40%.

In another aspect, the present invention is a soy protein isolate which, when mixed with 5 parts of water per part of soy protein isolate, by weight, forms a soy protein isolate/water mixture having a refrigerated gel strength of at least 800 grams of force. The soy protein isolate has a beta conglycinin content of from about 35% to about 85% and a glycinin content of from about 5% to about 40% and is obtained from high beta conglycinin soybeans.

In another aspect, the present invention is a soy protein isolate having a nitrogen solubility index of from 60% to 100% and a water hydration capacity of at least 6.5 times the weight of soy protein isolate. The soy protein isolate has a beta conglycinin content of from about 35% to about 85% and a glycinin content of from about 5% to about 40% and is obtained from high beta conglycinin soybeans.

In a further aspect, the present invention is a soy protein isolate having a nitrogen solubility index of from 60% to 100% and a salt tolerance index of from 60% 100%. The soy protein isolate has a beta conglycinin content of from about 35% to about 85% and a glycinin content of from about 5% to about 40% and is obtained from high beta conglycinin soybeans.

### DETAILED DESCRIPTION OF THE INVENTION

To provide an understanding of several of the terms used in the specification and claims, the following definitions are provided.

High beta-conglycinin soybeans: As used herein, high beta-conglycinin soybeans refers to soybean seeds having greater than about 40% of the protein as beta-conglycinil. Isolated soy protein (ISP): As used herein, Isolated soy protein is a spray-dried powder made from soybeans containing not less than 90% protein (N times 6.25) on a moisture-free basis.

High beta conglycinin soybeans seeds are processed into high beta conglycinin soy protein extracts as described below.

The Nitrogen-Ammonia-Protein Modified Kjeldahl Method of A.O.C.S. Methods Bc4-91 (1997), Aa 5-91 (1997), and Ba 4d-90(1997) used in the determination of the protein content may be performed as follows with a soy material sample. Between 0.0250-1.750 grams of the soy material are weighed into a standard Kjeldahl flask. A commercially available catalyst mixture of 16.7 grams potassium sulfate, 0.6 grams titanium dioxide, 0.01 grams of copper sulfate, and 0.3 grams of pumice is added to the flask, then 30 milliliters of concentrated sulfuric acid is added to the flask. Boiling stones are added to the mixture, and the sample is digested by heating the sample in a boiling water bath for approximately 45 minutes. The flask should be rotated at least 3 times during the digestion. 300 milliliters of water is added to the sample, and the sample is cooled to room temperature. Standardized 0.5N hydrochloric acid and distilled water are added to a distillate receiving flask sufficient to cover the end of a distillation outlet tube at the bottom of the receiving flask. Sodium hydroxide solution is added to the digestion flask in an amount sufficient to make the digestion solution strongly alkaline. The digestion flask is then immediately connected to the distillation outlet tube, the contents of the digestion flask are thoroughly mixed by shaking, and heat is applied to the digestion flask at about a 7.5-min boil rate until at least 150 milliliters of distillate is collected. The contents of the receiving flask are then titrated with 0.25N sodium hydroxide solution using 3 or 4 drops of methyl red indicator solution—0.1% in ethyl alcohol. A blank determination of all the reagents is conducted simultaneously with the sample and similar in all respects, and correction is made for blank determined on the reagents. The moisture content of the ground sample is determined according to the procedure described below (A.O.C.S Official Method Ba 2a-38). The nitrogen content of the sample is determined according to the formula: Nitrogen (%)=1400.67×[[(Normality of standard acid)×(Volume of standard acid used for sample (ml))]−[(Volume of standard base needed to titrate 1 ml of standard acid minus volume of standard base needed to titrate reagent blank carried through method and distilled into 1 ml standard acid (ml))×(Normality of standard base)]−[(Volume of standard base used for the sample (ml))×(Normality of standard base)]]/(Milligrams of sample). The protein content is 6.25 times the nitrogen content of the sample.

The term “weight on a moisture free basis” as used herein refers to the weight of a material after it has been dried to completely remove all moisture, e.g. the moisture content of the material is 0%. Specifically, the weight on a moisture free basis of a soy material can be obtained by weighing the soy material after the soy material has been placed in a 45° C. oven until the soy material reaches a constant weight.

The term “moisture content” as used herein refers to the amount of moisture in a material. The moisture content of a soy material can be determined by A.O.C.S. (American Oil Chemists Society) Method Ba 2a-38 (1997), which is incorporated herein by reference in its entirety. According to the method, the moisture content of a soy material may be measured by passing a 1000 gram sample of the soy material through a 6×6 riffle divider, available from Seedboro Equipment Co., Chicago, Ill., and reducing the sample size to 100 grams. The 100 gram sample is then immediately placed in an airtight container and weighed. 5 grams of the sample are weighed onto a tared moisture dish (minimum 30 gauge, approximately 50×20 millimeters, with a tight-fitting slip cover—available from Sargent-Welch Co.). The dish containing the sample is placed in a forced draft oven and dried at 130±3° C. for 2 hours. The dish is then removed from the oven, covered immediately, and cooled in a dessicator to room temperature. The dish is then weighed. Moisture content is calculated according to the formula: Moisture content (%)=100×[(loss in mass (grams)/mass of sample (grams)].

The term “refrigerated gel strength” as used herein is a measure of the strength of a gel of a soy material following refrigeration at −5° C. to 5° C. for a period of time sufficient for the gel to equilibrate to the refrigeration temperature. Refrigerated gel strength is measured by mixing a sample of soy material and water having a 1:5 soy material:water ratio, by weight (including the moisture content of the soy material in the water weight) for a period of time sufficient to permit the formation of a gel; filling a 3 piece 307×113 millimeter aluminum can with the gel and sealing the can with a lid; refrigerating the can for a period of 16 to 24 hours at a temperature of −5° C. to 5° C.; opening the can and separating the refrigerated gel from the can, leaving the gel sitting on the can bottom; measuring the strength of the gel with an instrument which drives a probe into the gel until the gel breaks and measures the break point of the gel (preferably an Instron Universal Testing Instrument Model No. 1122 with 36 mm disk probe); and calculating the gel strength from the recorded break point of the gel. The calculation of the gel strength is made according to the following formula: Gel Strength (grams)=(454)(Full Scale Load of the instrument required to break the gel)×(recorded break point of the gel (in instrument chart units out of a possible 100 chart units))/100.

The term “nitrogen solubility index” as used herein is defined as: (% water soluble nitrogen of a protein containing sample/% total nitrogen in protein containing sample)×100. The nitrogen solubility index provides a measure of the percent of water soluble protein relative to total protein in a protein containing material. The nitrogen solubility index of a soy material is measured in accordance with standard analytical methods, specifically A.O.C.S. Method Ba 11-65, which is incorporated herein by reference in its entirety. According to the Method Ba 11-65, 5 grams of a soy material sample ground fine enough so that at least 95% of the sample will pass through a U.S. grade 100 mesh screen (average particle size of less than about 150 microns) is suspended in 200 milliliters of distilled water, with stirring at 120 rpm, at 30° C. for two hours, and then is diluted to 250 milliliters with additional distilled water. If the soy material is a full-fat material the sample need only be ground fine enough so that at least 80% of the material will pass through a U.S. grade 80 mesh screen (approximately 175 microns), and 90% will pass through a U.S. grade 60 mesh screen (approximately 205 microns). Dry ice should be added to the soy material sample during grinding to prevent denaturation of sample. 40 milliliters of the sample extract is decanted and centrifuged for 10 minutes at 1500 rpm, and an aliquot of the supernatant is analyzed for Kjeldahl protein (PRKR) to determine the percent of water soluble nitrogen in the soy material sample according to A.O.C.S Official Methods Bc 4-91 (1997), Ba 4d-90, or Aa 5-91, as described above. A separate portion of the soy material sample is analyzed for total protein by the PRKR method to determine the total nitrogen in the sample. The resulting values of Percent Water Soluble Nitrogen and Percent Total Nitrogen are utilized in the formula above to calculate the nitrogen solubility index.

The term “water hydration capacity” as used herein is defined as the maximum amount of water a material can absorb and retain under low speed centrifugation (2000×g). The water hydration capacity of a soy material is determined by: 1) weighing a soy material sample; 2) measuring the moisture content of the sample according to A.O.C.S Method Ba 2a-38 described above; 3) determining the approximate water hydration capacity of the soy material sample by adding increments of water to the sample in a centrifuge tube until the sample is thoroughly wetted, centrifuging the wetted sample at 2000×g, decanting excess water, re-weighing the sample, and calculating the approximate water hydration capacity as the weight of the hydrated sample minus the weight of the unhydrated sample divided by the weight of the unhydrated sample; 4) preparing four samples of the soy material having the same weight as the unhydrated soy material sample determined in step 1 and having volumes of water calculated to encompass the approximate water hydration capacity value, where the volumes of water in milliliters are determined according to the formula: (approximate water hydration capacity×weight of the unhydrated sample in step 1)+Y, where Y=−1.5, −0.5, 0.5, and 1.5 for the respective four samples; 5) centrifuging the four samples and determining which two of the four samples encompass the water hydration capacity—one sample will have a small excess of water, and the other will have no excess water; and 6) calculating the water hydration capacity according to the formula: Water Hydration Capacity (%)=100×[(Volume of water added to the sample with excess water+Volume of water added to the sample with no excess water)]/[(2)×(Solids content of the soy material)]. The solids content of the soy material used in calculating the water hydration capacity is determined according to the formula: Solids content (%)=(Weight of the soy material sample measured in step 1)×[1.0−(Moisture content of the soy material measured in step 2/100)].

The term “salt tolerance index” as used herein is defined as the dispersible nitrogen content (expressed as protein) of a soy material in the presence of salt. The salt tolerance index measures the solubility of protein in the presence of salt. The salt tolerance index is determined according to the following method. Weighed into a 400 milliliter beaker is 0.75 grams of sodium chloride. Added to the beaker is 150 milliliters of water at 30±1° C., and the salt is dissolved completely in the water. The salt solution is added to a mixing chamber, and 5 grams of a soy material sample is added to the salt solution in the mixing chamber. The sample and salt solution are blended for 5 minutes at 7000 rpm±200 rpm. The resulting slurry is transferred to a 400 milliliter beaker, and 50 milliliters of water is used to rinse the mixing chamber. The 50 milliliter rinse is added to the slurry. The beaker of the slurry is placed in 30° C. water bath and is stirred at 120 rpm for a period of 60 minutes. The contents of the beaker are then quantitatively transferred to a 250 milliliter volumetric flask using deionized water. The slurry is diluted to 250 milliliters with deionized water, and the contents of the flask are mixed thoroughly by inverting the flask several times. 45 milliliters of the slurry are transferred to a 50 milliliter centrifuge tube and the slurry is centrifuged for 10 minutes at 500×g. The supernatant is filtered from the centrifuge tube through filter paper into a 100 milliliter beaker. Protein content analysis is then performed on the filtrate and on the original dry soy material sample according to A.O.C.S Official Methods Bc 4-91 (1997), Ba 4d-90, or Aa 5-91 described above. The salt tolerance index is calculated according to the following formula: STI (%)=(100)×(50)×[(Percent Soluble Protein (in filtrate))/(Percent Total Protein (of dry soy material sample))].

Soybean proteins are composed of four globulin fractions: 2S having a molecular weight from about 8,000 to about 21,500; 7S (beta-conglycinin) having a molecular weight from about 150,000 to about 200,000; 11S (glycinin) having a molecular weight of about 350,000 and 15S having a molecular weight of about 600,000.

The soy protein material utilized within the present invention has a beta conglycinin content of from about 35% to about 85% of the total weight of the soy protein and a glycinin content of from about 5% to about 40% of the total weight of the soy protein. The use of high beta conglycinin soybeans which contain more than about 40% beta conglycinin, enable the preparation of a soy protein material having a beta conglycinin content of from about 35% to about 85% without the inefficiencies of removing glycinins during processing. The high beta conglycinin soy protein material of the present invention contains from about 35% to about 85% beta conglycinin, compared to 26-29% in commercial soy protein isolates. Typically soy protein isolates, a typical starting material for beverages, contain about 40-45% glycinini. The high beta conglycinin soy protein material of the present invention contains less than about 40% glycinin.

High beta conglycinin soy protein isolate, as the term is used herein, refers to a soy protein material containing about 90% or greater protein content, and preferably about 95% or greater soy protein content, wherein the beta conglycinin fraction is from about 35% to about 85%, preferably from about 45% to about 70% and a glycinin content of from about 5% to about 40%, preferably from about 15% to about 35% of the total soy protein. The high beta conglycinin soy protein isolate is typically produced from a starting material, such as defatted high beta conglycinin soybean material, in which the oil is extracted to leave soybean meal or flakes. More specifically, the high beta conglycinin soybeans may be initially crushed or ground and then passed through a conventional oil expeller. Oil contained in the soybeans is removed by solvent extraction with aliphatic hydrocarbons, such as hexane or azeotropes thereof, and these represent conventional techniques employed for the removal of oil. After the hexane-oil phase is removed, the mixture left behind is called a “marc”, which denotes flakes wet with hexane. Heat treatment steps are introduced into the processing of the flakes. After the oil-hexane removal, the marc is heat treated to remove any remaining hexane to a hexane level of less than about 200 parts per million, preferably less than about 100 parts per million and most preferably less than about 50 parts per million at a temperature of from about 200° F. to about 210° F.

It is well settled that heat treating soybean flakes at this temperature is a means for introducing functionality into the isolate. However, while the functionality is increased, the yield of isolate is decreased. In the present invention, both the functionality and the yield are increased by using high beta conglycinin soybeans. Further, in the present invention, there is a surprising effect of an interaction between heat treated-high 7S soy flakes. This surprising effect is not noted in non-heat treated non high 7S soy flakes (commodity flakes).

The defatted, high beta conglycinin soy protein flakes are then placed in an aqueous bath to provide a mixture having a pH of at least about 6.5 and preferably between about 7.0 and 10 in order to extract the protein. Typically, if it is desired to elevate the pH above 6.7 various alkaline reagents such as sodium hydroxide, potassium hydroxide and calcium hydroxide or other commonly accepted food grade alkaline reagents may be employed to elevate the pH. A pH of above about 7 is generally preferred, since an alkaline extraction facilitates solubilization of the protein. Typically, the pH of the aqueous extract of the high beta conglycinin soy protein, will be at least about 6.5 and preferably about 7.0 to 10. The ratio by weight of the aqueous extractant to the soy protein material is usually between about 20 to 1 and preferably a ratio of about 10 to 1. In an alternative embodiment, the soy protein is extracted from the milled, defatted flakes with water, that is, without a pH adjustment.

It is also desirable in obtaining the high beta conglycinin soy protein isolate used in the present invention, that an elevated temperature be employed during the aqueous extraction step, either with or without a pH adjustment, to facilitate solubilization of the soy protein, although ambient temperatures are equally satisfactory if desired. The extraction temperatures which may be employed, can range from ambient up to about 120° F. with a preferred temperature of 90° F. The period of extraction is further non-limiting and a period of time between about 5 to 120 minutes may be conveniently employed with a preferred time of about 30 minutes. Following extraction of the vegetable protein material, the aqueous extract of protein can be stored in a holding tank or suitable container while a second extraction is performed on the insoluble solids from the first aqueous extraction step. This improves the efficiency and yield of the extraction process by exhaustively extracting the protein from the residual solids from the first step.

The combined, aqueous protein extracts from both extraction steps, without the pH adjustment or having a pH of at least 6.5, or preferably about 7.0 to 10, are then precipitated by adjustment of the pH of the soy extracts to, at or near the isoelectric point of the high beta conglycinin soy protein to form an insoluble curd precipitate. The pH is typically between about 4.0 and 5.0. The precipitation step may be conveniently carried out by the addition of a common food grade acidic reagent such as acetic acid, sulfuric acid, phosphoric acid, hydrochloric acid or with any other suitable acidic reagent. The high beta conglycinin soy protein precipitates from the acidified extract, and is then separated from the extract. The separated high beta conglycinin soy protein isolate may be washed with water to remove residual soluble carbohydrates and ash from the protein material. The separated protein is then dried using conventional drying means to form a high beta conglycinin soy protein isolate.

Preferably the high beta conglycinin soy protein material used in the present invention, is modified to enhance the characteristics of the soy protein material. The modifications are modifications which are known in the art to improve the utility or characteristics of a soy protein material and include, but are not limited to, denaturation and hydrolysis of the protein material.

The high beta conglycinin soy protein material may be denatured and hydrolyzed to lower the viscosity. Chemical denaturation and hydrolysis of protein materials is well known in the art and typically consists of treating a protein material with one or more alkaline reagents in an aqueous solution under controlled conditions of pH and temperature for a period of time sufficient to denature and hydrolyze the protein material to a desired extent. Typical conditions utilized for chemical denaturing and hydrolyzing the high beta conglycinin soy protein material are: a pH of up to about 10, preferably up to about 9.7; a temperature of about 50° C. to about 80° C. and a time period of about 15 minutes to about 3 hours, where the denaturation and hydrolysis of the protein material occurs more rapidly at higher pH and temperature conditions.

Hydrolysis of the high beta conglycinin soy protein material may also be effected by treating the soy protein material with an enzyme capable of hydrolyzing the protein. Many enzymes are known in the art which hydrolyze protein materials, including, but not limited to, fungal proteases, pectinases, lactases, and chymotrypsin. Enzyme hydrolysis is effected by adding a sufficient amount of enzyme to an aqueous dispersion of protein material, typically from about 0.1% to about 10% enzyme by weight of the protein material, and treating the enzyme and protein dispersion at a temperature, typically from about 5° C. to about 75° C., and a pH, typically from about 3 to about 9, at which the enzyme is active for a period of time sufficient to hydrolyze the soy protein material. After sufficient hydrolysis has occurred the enzyme is deactivated by heating, and the soy protein material is precipitated from the solution by adjusting the pH of the solution to about the isoelectric point of the protein material.

The soy protein isolate of the functional food ingredient of the present invention contains significant amounts of partially denatured soy protein, which provides substantial functionality to the soy material. Soy protein in its native state is a globular protein having a hydrophobic core surrounded by a hydrophilic shell. Native soy protein is very soluble in water due to its hydrophilic shell. The partially denatured soy proteins in the soy protein isolate of the present invention have been partially unfolded and realigned so that hydrophobic and hydrophilic portions of adjacent proteins may overlap. The partially denatured soy proteins, however, have not been denatured to such an extent that the proteins are rendered insoluble in an aqueous solution. In an aqueous solution, the partially denatured soy proteins of the soy material form large aggregates wherein the exposed hydrophobic portions of the partially denatured proteins are aligned with each other to reduce exposure of the hydrophobic portions to the solution. These aggregates promote the formation of gels, increase gel strength, and increase viscosity of the soy material.

The degree of denaturation of the soy protein in the soy protein isolate is measurable, in part, by the solubility of the protein in an aqueous solution, which is related to the nitrogen solubility index of the soy protein isolate. Soy materials containing highly aqueous-soluble soy protein have a nitrogen solubility index of greater than 60%, while soy materials containing large quantities of aqueous-insoluble soy protein have a nitrogen solubility index less than 25%. The soy protein isolate of the food ingredient composition of the present invention has a nitrogen solubility index of from about 60% to about 100%. More preferably, the soy protein isolate has a nitrogen solubility index of from about 65% to about 95%, and most preferably from about 90% to about 70%.

The soy proteins in the soy protein isolate of the functional food ingredient of the present invention retain their partial solubility in an aqueous system containing salt (sodium chloride). This is a particularly important feature of the soy protein isolate of the functional food ingredient of the invention, since the soy protein isolate is useful as a food ingredient in food systems containing significant amounts of salt. In an aqueous system, soluble or partially soluble soy protein has a tendency to become insoluble or “salts out” when a significant amount of salt is added to the aqueous system. In food systems that contain relatively high amounts of salt, such as emulsified meats or soups, insoluble soy protein caused by “salting out” is highly undesirable.

The soy protein isolate of the food ingredient of the present invention contains soy protein that is not significantly susceptible to “salting out”. The soy protein isolate of the present invention has a salt tolerance index, a measure of protein solubility comparable to the nitrogen solubility index which is measured in a salt containing system, of from 60% to 100%. More preferably, the soy protein isolate of the food ingredient of the present invention has a salt tolerance index of from about 65% to about 95%, and most preferably from about 70% to about 90%.

The soy protein isolate of the food ingredient of the present invention is capable of forming a substantial gel in an aqueous solution due, in part, to the aggregation of the partially denatured proteins of the soy protein isolate. Substantial gel formation in an aqueous environment is a desirable quality of the food ingredient composition of the present invention since the gelling properties of the soy protein isolate contribute to the texture and structure of meat products in which the soy protein isolate is used, as well as provide a matrix for retaining moisture and fats in the meat products to enable a cooked meat product containing the soy protein isolate to retain its juices during cooking.

The soy protein isolate of the food ingredient of the present invention is capable of forming a gel of sufficient gel strength so the soy protein isolate can be utilized in a meat emulsion to provide a meat emulsion having a firm texture. The soy protein isolate has a refrigerated gel strength of at least 800 grams of force when combined with five parts of water per one part of the soy protein isolate. More preferably, the soy protein isolate has a refrigerated gel strength in a 5:1 water:soy material mixture of at least 900 grams of force, and most preferably has a refrigerated gel strength of at least 1000 grams of force in a 5:1 water:soy material mixture. The soy protein isolate of the food ingredient composition of the present invention also has a substantial water hydration capacity. Water hydration capacity, a direct measure of the ability of a material to absorb and retain moisture, is desirable in a food ingredient utilized in meat emulsions since a material having a relatively high water hydration capacity absorbs and retains moisture released by meat materials upon cooking, thereby retaining the juices of the cooked meat and providing improved weight retention of the meat emulsion in the cooking process. Incorporation of the soy protein isolate in a meat emulsion, therefore, leads to improved taste and tenderness of the cooked meat emulsion and an improved cooked weight yield relative to cooked meat emulsions which do not contain a food ingredient with a high water hydration capacity.

The relatively high water hydration capacity of the soy protein isolate of the food ingredient of the present invention is believed to be due to enhanced water hydration capacity of fiber in the soy protein isolate relative to fiber in conventional soy protein isolates, as well as to the partial denaturation of the soy protein in the soy protein isolate of the food ingredient of the present invention. The process of forming the soy protein isolate, as described hereinafter, exposes the soy material to relatively high temperatures which expands fiber and denatures protein in the soy protein isolate in the presence of water. The soy protein isolate is dried rapidly, which causes the fiber to retain its expanded structure and the protein to retain its denatured structure. Upon addition of the soy protein isolate to an aqueous system, the expanded fiber and the denatured protein absorb substantial amounts of water, resulting in the relatively high water hydration capacity of the soy protein isolate. Preferably, the soy protein isolate has a water hydration capacity of at least 6.5 times the weight of the soy protein isolate, and more preferably at least 7.0 times the weight of the soy protein isolate.

In another preferred embodiment, the functional food ingredient of the present invention is a soy protein isolate containing at least 90% soy protein by weight on a moisture free basis, a refrigerated gel strength of at least 800 grams of force when the soy protein isolate is combined with five parts of water per part of soy material, by weight, and more preferably at least 900 grams of force, and most preferably at least 1000 grams of force. The soy protein isolate of the functional food ingredient also preferably has at least one of the following characteristics: a nitrogen solubility index of from 60% to 100%, more preferably from 65% to 95%, and most preferably from 70% to 90%; a salt tolerance index of from 60% to 100%, more preferably from 65% to 95%, and most preferably from 70% to 90%; and a water hydration capacity of at least 6.5 times the weight of the soy material.

Isolates are prepared from soy flakes derived from both commodity soybeans and high 7S soybeans. Examples are as follows.

### EXAMPLE 1

Commodity soy flakes from commodity soybeans, prepared without any heat treatment are used to prepare a soy protein isolate. Fifty pounds of commercially available commodity soy flakes are mixed with two hundred pounds of water at a temperature of about 85° C. in an agitated mixing tank. A first extraction pH is as-is with no chemical adjustment. The first extraction slurry is separated in a centrifugal separator. The first extract, is pumped to a combined extract line while the first spent flakes are reslurried with 60 pounds of water for a second slurry. A second separation gives a second extract which is added to the first extract. The combined extract is heated to 122° F. and precipitated to pH 4.45±0.05 using 37% aqueous HCl to form curds (solid) and whey (liquid). These contents are then centrifuged and the precipitated protein is then diluted with water to form a slurry. The pH of the slurry is adjusted to about 7 by the addition of sodium hydroxide, such that the curds are solubilized. The solubilized protein is then spray dried to form an isolate having a 7S content of about 31% and an 11S content of about 57%.

### EXAMPLE 2

The procedure of Example 1 is repeated except that the commodity soy flakes from commodity soybeans are heat treated prior to extraction. The formed isolate has a 7S content of about 26% and an 11S content of about 53%.

### EXAMPLE 3

The procedure of Example 1 is repeated using soy flakes derived from high 7S soybeans from Monsanto, St. Louis, Mo., identified as DJB2104GOR wherein the soy flakes have a 7S content of about 39% and an 11S content of about 12%. The soy flakes are not subjected to a heat treatment. The formed isolate has a 7S content of about 37% and an 11S content of about 11%.

### EXAMPLE 4

The procedure of Example 3 is repeated except that the Monsanto soy flakes are heat treated prior to extraction. The formed isolate has a 7S content of about 38% and an 11S content of about 12%.

Salt is present in emulsified foods such as fish, meat or meat analog products that contain vegetable proteins. Salt sensitivity thus becomes a screening test or tool for evaluating vegetable proteins. The controlled salt sensitivity of a vegetable protein that contains 2% salt is indicative of the feasibility of the emulsified food that contains vegetable proteins.

The above prepared isolates are evaluated in a mini gel test to determine the gel strength on a small scale. In the mini gel test, gels are prepared from soy protein isolates in a 1 part isolate to 6 parts water both with and without the addition of salt, according to the below procedure. The moisture content of the isolate is part of the 6 parts of water. The following is the procedure for preparing a 1:6 gel using an isolate having a moisture content of 3.56%.

60 ml total volume/7 parts=8.57 g/96.55% solids=8.89 g isolate needed along with 51.11 g water.

Add the water to a Waring blender jar along with the protein sample and cover the jar. When preparing a gel with salt add the salt (2% or 1.2 g) at this point. Blend the mixture for 15 seconds on speed 1 to form a gel. Remove the jar from the blender base and scrape the sides and bottom with a spatula. Return the jar to the blender base and resume blending for another 15 seconds. Ensure that no lumps are present. Fill each of two Nalgene jars with the gel and remove any voids by using the spatula and tapping the jar on a bench top. Filled the Nalgene jars to capacity and level with a spatula and cap tightly. Boil the filled jars for 10 minutes and cool down to room temperature in an ice bath and refrigerate overnight. Remove the sample jars from the refrigerator and warm to room temperature on the bench for approximately 30 minutes. Remove the gel from the Nalgene jar by using a thin, narrow blade spatula inserted between the gel and the jar until the gel slides out. Determine the gel strength by using a Texture Analyzer and a TA25 probe. The compression level is set to 80% distance into the original height of the gel and record results in g force.

The results of the mini gel test are summarized in Tables 1 and 2.

TABLE 1

| | Gel Force | | Gel Force | |
|---|---|---|---|---|
| Example No | (No Heat, No Salt) | | (Heat, No Salt) | % Change |
| 1 | 1000 | g force | 2800 | +180 |
| 3 | 200 | | 17,000 | +840 |

TABLE 2

| | Gel Force | | Gel Force | |
|---|---|---|---|---|
| Example No | (No Heat, Salt) | | (Heat, Salt) | % Change |
| 2 | 700 | g force | 1300 | +85 |
| 4 | 700 | | 7500 | +971 |

Based upon the no salt data in Table 1, there is a surprising interaction, a synergistic effect between an isolate prepared from high 7S beans in conjunction with a heat treatment step versus an isolate prepared from commodity beans, not having a high 7S content in conjunction with a non-heat treating step. The gel strength increases 840% by the heat treatment of a high 7S isolate, whereas the gel strength only increases 180% by the heat treatment of a commodity isolate.

Based upon the salt data in Table 2, there is a surprising interaction, a synergistic effect between an isolate prepared from high 7S beans in conjunction with a heat treatment step versus an isolate prepared from commodity beans, not having a high 7S content in conjunction with a non-heat treating step. The gel strength increases 971% by the heat treatment of a high 7S isolate, whereas the gel strength only increases 85% by the heat treatment of a commodity isolate.

A meat emulsion containing the isolated soy protein functional food ingredient as described above is prepared as per the following. The ingredients are measured out in the correct weight percentages, so the total emulsion will weigh 4000 grams.

### EXAMPLE 5

| | Percent, | |
|---|---|---|
| Ingredient | by weight | Wt (g) |
| Isolated soy protein material | 8.2 | 328.0 |
| sodium tripolyphosphate | 0.4 | 16.0 |
| Pork 90 | 10.0 | 400.0 |
| Mechanically deboned chicken (18% fat) | 22.0 | 880.0 |
| Pork Back Fat | 18.3 | 733.2 |
| Pork Skin Emulsion | 7.0 | 280.0 |
| Water | 28.6 | 1145.0 |
| Salt | 2.0 | 80.0 |
| Spice Mix | 0.4 | 14.4 |
| Carbohydrates (dextrose, corn syrup solids) | 3.0 | 120.0 |
| Preservatives | 0.1 | 3.4 |

The Pork 90, mechanically deboned chicken, pork back fat, and pork skin emulsion are tempered at 10° C. overnight. The Pork 90 and Pork Back Fat are then ground to ⅛ inch in a grinder with ⅛ inch plates. The Pork 90, mechanically deboned chicken, ½ of the water and ½ of the functional food ingredient are chopped together at low speed for 30 seconds in a Stephen Cutter with vacuum and temperature probe. The remaining ingredients are added, and a vacuum is pulled while chopping on low for 30 seconds, then the ingredients are chopped at high speed until the product achieves a temperature of 14° C. 48 mm flat width, 30 cm length PVDC casings are then stuffed with the chopped ingredients. The stuffed casings are held in ice water for at least 30 minutes, and then are cooked in an 80° C. water kettle cooker to an internal temperature of 73° C. The cooked meat emulsion is then cooled in ice water.

The present invention is also directed to a process for preparing a soy protein isolate functional food ingredient, the process comprising;

de-oiling hexane treated soybean flakes;

heat treating the de-oiled hexane treated soybean flakes to a hexane content of below 200 parts per million at a temperature of from about 200° F. to about 210° F., wherein the soybean flakes are from high beta conglycinin soybeans;

mixing the heat treated soybean flakes with water to form a slurry;

removing fiber from the slurry to produce a liquor;

adding an acid to the liquor to produce a precipitate of curds and a liquid of whey;

separating the curds and the whey;

washing the curds with water;

adjusting the pH of the washed curds to about 7 and

drying the pH adjusted material to produce a soy protein isolate having a beta conglycinin content of from about 35% to about 85% and a glycinin content of from about 5% to about 40%.

desolventizing defatted soybean flakes having a residual hexane content of from about 20% to about 40% at a temperature of from about 200° F. to about 210° F., wherein the soybean flakes are from high beta conglycinin soybeans;

mixing the defatted soybean flakes with water to form a slurry;

removing fiber fi-om the slurry to produce a liquor;

adding an acid to the liquor to produce a precipitate of curds and a liquid of whey;

separating the curds and the whey; and

drying the curds to produce a soy protein isolate having a beta conglycinin content of from about 35% to about 85% and a glycinin content of from about 5% to about 40%.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A functional food ingredient, comprising;
a soy protein isolate having a beta conglycinin content of from about 35% to about 85% and a glycinin content of from about 5% to about 40% and wherein the soy protein isolate is prepared by a process, comprising;
de-oiling hexane treated soybean flakes;
heat treating the de-oiled hexane treated soybean flakes to a hexane content of below 200 parts per million at a temperature of from about 200° F. to about 210° F., wherein the soybean flakes are from high beta conglycinin soybeans;
mixing the heat treated soybean flakes with water to form a slurry;
removing fiber from the slurry to produce a liquor;
adding an acid to the liquor to produce a precipitate of curds and a liquid of whey;
separating the curds and the whey;
washing the curds with water;
adjusting the pH of the washed curds to about 7 and
drying the pH adjusted material to produce a soy protein isolate having a beta conglycinin content of from about 35% to about 85% and a glycinin content of from about 5% to about 40%.

2. A process for preparing a soy protein isolate functional food ingredient, the process comprising;
de-oiling hexane treated soybean flakes;
heat treating the de-oiled hexane treated soybean flakes to a hexane content of below 200 parts per million at a temperature of from about 200° F. to about 210° F., wherein the soybean flakes are from high beta conglycinin soybeans;
mixing the heat treated soybean flakes with water to form a slurry;
removing fiber from the slurry to produce a liquor;
adding an acid to the liquor to produce a precipitate of curds and a liquid of whey;
separating the curds and the whey;
washing the curds with water;
adjusting the pH of the washed curds to about 7 and
drying the pH adjusted material to produce a soy protein isolate having a beta conglycinin content of from about 35% to about 85% and a glycinin content of from about 5% to about 40%.
The present invention is also directed to a process for preparing a soy protein isolate functional food ingredient.
